(19) United States
(12) Patent Application Publication
(10) Pub. No.: US 2020/0051436 A1
(43) Pub. Date: Feb. 13, 2020

(54) VEHICLE CONTROL APPARATUS AND VEHICLE CONTROL METHOD

(71) Applicant: HONDA MOTOR CO., LTD., MINATO-KU, TOKYO (JP)

(72) Inventors: Jun OCHIDA, WAKO-SHI, SAITAMA-KEN (JP); Hiroaki HORII, WAKO-SHI, SAITAMA-KEN (JP); Takashi KUBOSHIMA, WAKO-SHI, SAITAMA-KEN (JP); Tadahiko KANOU, WAKO-SHI, SAITAMA-KEN (JP)

(21) Appl. No.: 16/498,914

(22) PCT Filed: Mar. 30, 2017
(86) PCT No.: PCT/JP2017/013321

§ 371 Date: Sep. 27, 2019

(51) Int. Cl. G08G 1/16; G08G 1/01

(52) U.S. Cl. CPC G08G 1/166; G08G 1/0125; G08G 1/167

(57) ABSTRACT

The present invention pertains to a vehicle control apparatus and a vehicle control method. This vehicle control apparatus is provided with: an identification process unit that identifies intersections through which a host vehicle passes while traveling straight; a lane determination unit that determines whether travel lanes of the vehicle are offset lanes deviated leftward or rightward on the near side and the deep side of the identified intersections; and a traveling control unit that carries out traveling control varied according to the determination result of the lane determination unit.

### TECHNICAL FIELD

The present invention relates to a vehicle control device (apparatus) and a vehicle control method.

### BACKGROUND ART

Various control devices that acquire information expressing an external environment state of a host vehicle (hereinafter, external environment information) and perform driving assistance or automated driving on the basis of the external environment information have conventionally been developed.

Japanese Laid-Open Patent Publication No. 2003-121180 discloses a method of generating a virtual road on the basis of map information and measuring the position of a host vehicle in the map by using what is called map matching. According to the method disclosed in this literature, the position of the host vehicle can be recognized accurately when the host vehicle passes an intersection or a branch point.

### SUMMARY OF INVENTION

However, in the method disclosed in Japanese Laid-Open Patent Publication No. 2003-121180, the accuracy of recognizing the position of the host vehicle largely depends on the reliability of the map information. For example, if it is recognized that a lane over the intersection is shifted with respect to the lane before the intersection in a left-right direction, it may be difficult to understand an actual travel scene accurately. In particular, if automated travel control is performed, it is assumed that it may be difficult to determine how to pass this intersection.

The present invention has been made to solve the above problem, and an object is to provide a vehicle control device and a vehicle control method that enable a host vehicle to travel straight in an intersection as appropriate while the connectivity of a travel lane in a front-rear direction in the intersection is considered.

A vehicle control device according to a first aspect of the present invention is a device configured to perform travel control of a host vehicle at least partially automatically, the device including: a recognition processing unit configured to recognize an intersection that the host vehicle will pass while traveling straight; a lane determination unit configured to determine whether a travel lane of the host vehicle is an offset lane in which the travel lane over the intersection that is recognized by the recognition processing unit is shifted with respect to the travel lane before the intersection in a left-right direction; and a travel control unit configured to perform various kinds of travel control in accordance with a determination result from the lane determination unit.

As described above, by performing various kinds of travel control in accordance with the determination result regarding the offset lane, the host vehicle can travel straight in the intersection as appropriate while the connectivity of the travel lane in a front-rear direction in the intersection is considered.

The recognition processing unit may be configured to further recognize lane marks that express section lines of the travel lane, and the lane determination unit may be configured to set virtual section lines in the intersection by performing extrapolation of near side section lines of the intersection specified by the lane marks, and determine whether the travel lane is the offset lane on the basis of the virtual section lines.

If it is determined that the travel lane is the offset lane, the lane determination unit may set the virtual section lines by reconnecting the near side section lines to far side section lines that are closest to the near side section lines in an offset direction.

The travel control unit may be configured to perform lane keep control for the virtual section lines set by the lane determination unit in the intersection.

The recognition processing unit may be configured to further recognize one or a plurality of particular objects ahead of the host vehicle, and if at least a part of the particular object is on the same side as the host vehicle with respect to the virtual section line, the lane determination unit may determine that the travel lane is the offset lane. Thus, the determination can be performed with high accuracy by using the positional relation with the particular object that may exist in the next lane (that is, opposite lane).

The recognition processing unit may be configured to recognize, as the particular object, an oncoming vehicle ahead of the host vehicle and/or a stop line over the intersection.

The recognition processing unit may be configured to further recognize a preceding vehicle ahead of the host vehicle, and if the recognition processing unit recognizes the preceding vehicle, the travel control unit may perform following control for the preceding vehicle in the intersection. Thus, the host vehicle can pass the intersection in accordance with the behavior of the preceding vehicle without considering the connectivity of the travel lane.

The vehicle control device may further include a takeover request unit to request a driver of the host vehicle to perform a takeover for manual driving if the recognition processing unit does not recognize the particular object or the preceding vehicle. Thus, in a situation where it is difficult to determine the connectivity of the travel lane, the driver can smoothly start to drive.

If it is determined that the travel lane is the offset lane, the lane determination unit may set the virtual section lines in the intersection by connecting near side section lines with respect to the intersection to far side section lines that are closest to the near side section lines in an offset direction.

A vehicle control method according to a second aspect of the present invention is a method using a vehicle control device configured to perform travel control of a host vehicle at least partially automatically, the method including: a recognition step of recognizing an intersection that the host vehicle will pass while traveling straight; a determination step of determining whether a travel lane of the host vehicle is an offset lane in which the travel lane over the recognized intersection is shifted with respect to the travel lane before the intersection in a left-right direction; and a control step of performing various kinds of travel control in accordance with a determination result in the determination step.

By the vehicle control device and the vehicle control method according to the present invention, the host vehicle can travel straight in the intersection as appropriate while the connectivity of the travel lane in the front-rear direction in the intersection is considered.

### BRIEF DESCRIPTION OF DRAWINGS

FIG. 1 is a block diagram illustrating a configuration of a vehicle control device according to one embodiment of the present invention;

FIG. 2 is a flowchart for describing an operation of the vehicle control device illustrated in FIG. 1;

FIG. 3A illustrates a first example of an intersection that a host vehicle will pass, and FIG. 3B illustrates a result of setting virtual section lines in the intersection in FIG. 3A;

FIG. 4 is a detailed flowchart regarding a secondary determination process (step S8 in FIG. 2);

FIG. 5 illustrates a second example of the intersection that the host vehicle will pass;

FIG. 6 illustrates a result of temporarily setting virtual section lines in the intersection in FIG. 5;

FIG. 7A and FIG. 7B illustrate a positional relation between the host vehicle and a particular object (forward other vehicle);

FIG. 8 illustrates a positional relation between the host vehicle and particular objects (stop lines);

FIG. 9A illustrates the travel behavior of the host vehicle in the situation in FIG. 7B, and FIG. 9B illustrates the travel behavior of the host vehicle in the situation in FIG. 8; and

FIG. 10 illustrates the travel behavior of the host vehicle in the situation in FIG. 7A.

### DESCRIPTION OF EMBODIMENTS

A preferred embodiment of a vehicle control device and a vehicle control method according to the present invention is hereinafter described with reference to the attached drawings.

### [Configuration of Vehicle Control Device 10]

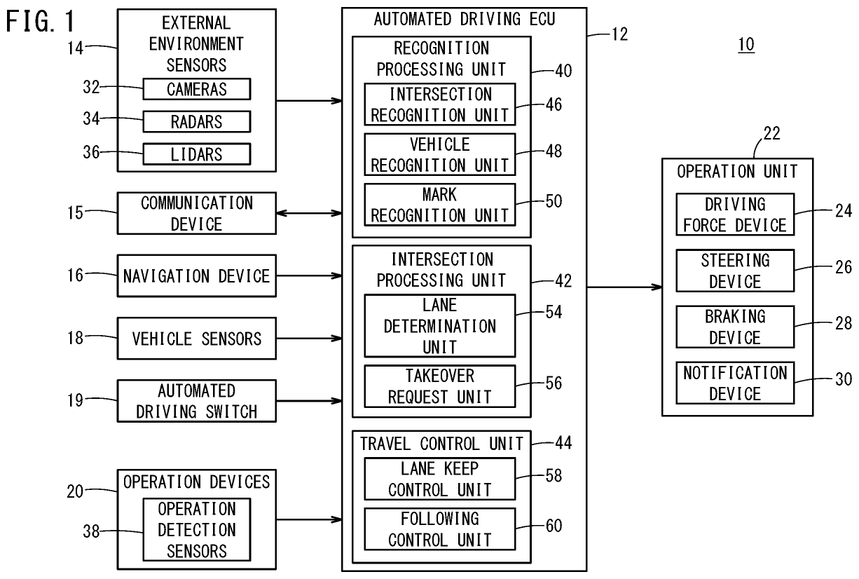

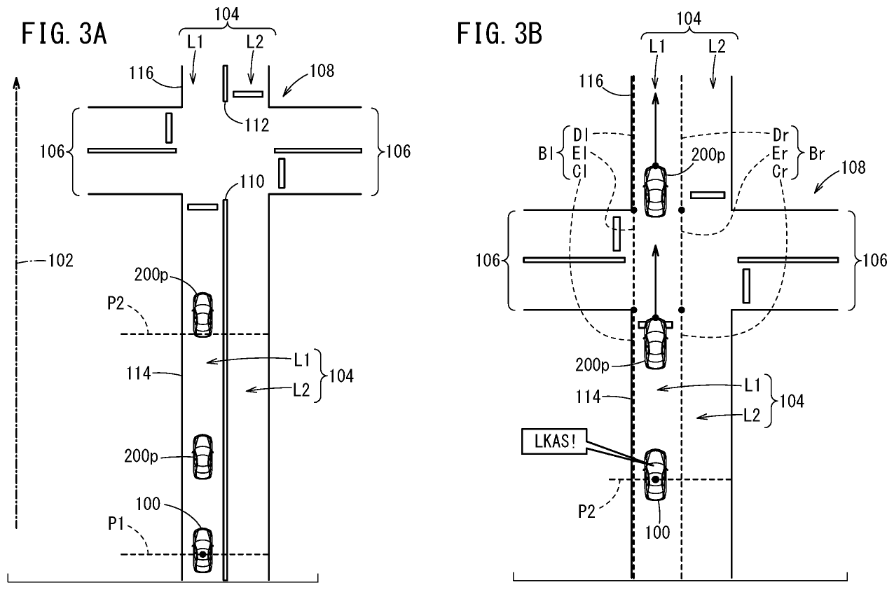

FIG. 1 is a block diagram illustrating a configuration of a vehicle control device 10 according to one embodiment of the present invention. The vehicle control device 10 is incorporated in a vehicle (host vehicle 100 in FIG. 3A, etc.), and performs travel control of the vehicle automatically or manually. This “automated driving” refers to a concept including not just “fully automated driving” in which the travel control of the vehicle is fully automated but also “partially automated driving” in which the travel control is partially automated.

The vehicle control device 10 basically includes an input system device group, an automated driving ECU (Electronic Control Unit) 12, and an output system device group. Devices in the input system device group and the output system device group are connected to the automated driving ECU 12 through communication lines.

The input system device group includes external environment sensors 14, a communication device 15, a navigation device 16, vehicle sensors 18, an automated driving switch 19, and operation devices 20. The output system device group (corresponding to an operation unit 22) includes a driving force device 24 that drives wheels, a steering device 26 that steers the wheels, a braking device 28 that brakes the wheels, and a notification device 30 that notifies a driver.

### <Specific Configuration of Input System Device Group>

The external environment sensors 14 acquire information expressing an external environment state of the vehicle (hereinafter, external environment information), and output the external environment information to the automated driving ECU 12. The external environment sensors 14 specifically include a plurality of cameras 32, a plurality of radars 34, and a plurality of LIDARs 36 (Light Detection and Ranging, Laser Imaging Detection and Ranging).

The communication device 15 is configured to be able to communicate with external devices including a road side machine, another vehicle, and a server. For example, the communication device 15 transmits and receives information regarding traffic equipment, information regarding other vehicles, probe information, or map information that is the latest.

The navigation device 16 includes a satellite positioning device that can detect the current position of the vehicle, and a user interface. The navigation device 16 calculates a route to a designated destination on the basis of the current position of the vehicle or the position designated by a user, and outputs to the automated driving ECU 12, route information that expresses this route.

The vehicle sensors 18 include a speed sensor that detects travel speed of the vehicle (vehicle speed), an acceleration sensor that detects acceleration, a lateral acceleration sensor that detects lateral acceleration, a yaw rate sensor that detects angular speed around a vertical axis, an azimuth sensor that detects a direction/azimuth, and an inclination sensor that detects inclination. The vehicle sensors 18 output detection signals from these sensors to the automated driving ECU 12.

The automated driving switch 19 is a hardware switch or a software switch, and can switch a plurality of driving modes by a manual operation of the user including the driver.

The operation devices 20 include an accelerator pedal, a steering wheel, a brake pedal, a shift lever, and a direction indicating lever. Operation detection sensors 38 are attached to the operation devices 20. The operation detection sensors 38 detect the presence or absence of the driver's operation, the operation amount, and an operation position.

### <Specific Configuration of Output System Device Group>

The driving force device 24 includes a driving force control ECU and a driving source including an engine or a traction motor. The driving force device 24 generates travel driving force (torque) for the vehicle in accordance with a travel control value that is input from the automated driving ECU 12 (more specifically, travel control unit 44), and transmits the travel driving force to the wheels directly or indirectly through a transmission.

The steering device 26 includes an EPS (electric power steering system) ECU and an EPS device. The steering device 26 changes the direction of the wheels (steering wheels) in accordance with the travel control value that is input from the travel control unit 44.

The braking device 28 is, for example, an electric servo brake that is used in combination with a hydraulic brake, and includes a braking force control ECU and a brake actuator. The braking device 28 brakes the wheels in accordance with the travel control value that is input from the travel control unit 44.

The notification device 30 includes an output device including a display device and an audio device, and a notification control device. The notification device 30 performs a notification operation regarding the automated driving or the manual driving in accordance with a notification instruction that is output from the automated driving ECU 12.

### <Driving Mode>

The automated driving ECU 12 is set such that “automated driving mode” and “manual driving mode” (non-automated driving mode) are switched every time the automated driving switch 19 is pushed.

The automated driving mode is a driving mode in which the vehicle travels under control by the automated driving ECU 12 in a state where the driver does not operate the operation devices 20 (specifically, an accelerator pedal, a steering wheel, or a brake pedal). In other words, the automated driving mode is a driving mode in which the automated driving ECU 12 controls the driving force device 24, the steering device 26, and the braking device 28 partially or entirely in accordance with an action plan that is created successively.

If the driver performs a predetermined operation with the operation devices 20 in the automated driving mode, the automated driving mode is canceled automatically and switched to the driving mode with a relatively low driving automated level (including the manual driving mode). The driver's operation of the automated driving switch 19 or the operation devices 20 for the transition from the automated driving to the manual driving is hereinafter also referred to as “takeover operation”.

### <Configuration of Automated Driving ECU 12>

A function achievement unit of the automated driving ECU 12 is a software function unit that achieves a function when one or a plurality of CPUs (Central Processing Units) execute programs stored in the storage device that is non-transitory. The function achievement unit may alternatively be a hardware function unit including an integrated circuit such as an FPGA (Field-Programmable Gate Array).

This automated driving ECU 12 includes a recognition processing unit 40, an intersection processing unit 42, and the travel control unit 44. The recognition processing unit 40 functions as an intersection recognition unit 46, a vehicle recognition unit 48, and a mark recognition unit 50. The intersection processing unit 42 functions as a lane determination unit 54 and a takeover request unit 56. The travel control unit 44 functions as a lane keep control unit 58 and a following control unit 60.

The recognition processing unit 40 recognizes a mark such as a lane mark, a stop line, and a traffic signal with reference to various pieces of information input from the input system device group (such as external environment information from the external environment sensors 14), and then, generates “static” external environment recognition information including positional information about the mark or a travel possible area of the vehicle. In addition, the recognition processing unit 40 generates “dynamic” external environment recognition information including an obstacle such as a parked or stopped vehicle, a traffic participant such as a person or another vehicle, or the color of the traffic signal with reference to various pieces of information that are input.

The intersection processing unit 42 performs processing control (to be described below in detail) for a specified intersection that is recognized by the recognition processing unit 40. Then, the intersection processing unit 42 generates a signal (control signal) to perform the processing control, and outputs this control signal to the travel control unit 44 or the notification device 30.

By using the external environment recognition information that is generated by the recognition processing unit 40, the travel control unit 44 generates a travel trajectory (target behavior in time series) in accordance with the action plan for each travel section, and then, decides various travel control values for controlling the travel of the vehicle. The travel control unit 44 outputs the obtained travel control values to the driving force device 24, the steering device 26, and the braking device 28.

Note that the travel control unit 44 can perform lane keep control by the lane keep control unit 58 (hereinafter, LKAS control; Lane Keep Assist System) and following control by the following control unit 60 (hereinafter, ACC control; Adaptive Cruise Control). In addition, the travel control unit 44 may be able to perform departure prevention control (hereinafter, LDPS control; Lane Departure Prevention System).

Here, the term “LKAS control” means travel control to cause the vehicle to travel along a target trajectory (for example, the center line) on a travel lane L1 (for example, FIG. 3A). The term “ACC control” means travel control to cause the vehicle to travel so as to follow a travel trajectory of a preceding vehicle 200p (for example, FIG. 3A). The term “LDPS control” means travel control to cause the vehicle to travel such that the departure from a lane mark 110 (for example, FIG. 3A) to the outside is suppressed or prevented.

### [Operation of Vehicle Control Device 10]

### <1. Vehicle Passes Intersection 108>

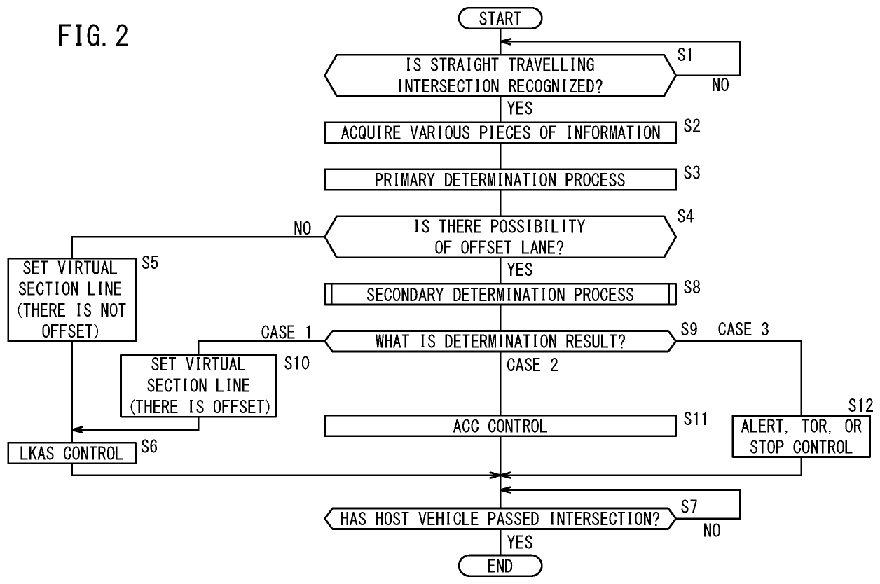

The vehicle control device 10 according to the present embodiment is configured as above. Next, an operation of the vehicle control device 10 before and after passing of an intersection 108 is described with reference to a flowchart in FIG. 2. Here, it is assumed that the host vehicle 100 including the vehicle control device 10 in FIG. 1 travels by the automated driving mode.

In step S1 in FIG. 2, the intersection recognition unit 46 determines whether the intersection recognition unit 46 has recognized the intersection 108 (straight travelling intersection) that the host vehicle 100 will pass while traveling straight on the basis of a detection result from the external environment sensors 14.

As illustrated in FIG. 3A, the host vehicle 100 will pass a point where a first road 104 and a second road 106 intersect (that is, intersection 108) along a scheduled travel route 102 that is expressed by a dashed line arrow. These drawings express the roads in a region where vehicles should travel on “left side” of the road.

Both the first road 104 and the second road 106 include two lanes (one lane on one side). The first road 104 includes, from a left side thereof, a lane where the host vehicle 100 travels (hereinafter, travel lane L1) and a lane L2 that is opposite to the travel lane L1.

The lane mark 110 with a continuous linear shape is a section line between the travel lane L1 and the lane L2 before the intersection 108. A lane mark 112 with a continuous linear shape is a section line between the travel lane L1 and the lane L2 over the intersection 108. That is to say, the travel lane L1 is sectioned by the lane marks 110, 112 and road ends 114, 116.

Note that a recognition position P1 expressed by a broken line is a position of the host vehicle 100 when the intersection 108 is recognized for the first time (recognition start time point). For the convenience of description, it is assumed that, after the recognition start time point, the vehicle recognition unit 48 always recognizes the two preceding vehicles 200p, and the mark recognition unit 50 always recognizes the lane marks 110, 112.

If the intersection 108 has not been recognized (step S1: NO), the process remains at step S1 until the intersection 108 is recognized. On the other hand, if the host vehicle 100 reaches the recognition position P1 and the intersection 108 has been recognized for the first time (step S1: YES), the process advances to step S2.

In step S2, the automated driving ECU 12 acquires various pieces of information used for primary and secondary determination processes to be described below. The information includes positional information of the lane marks 110, 112 and the road ends 114, 116, and the kind, position, or movement of a recognized object (for example, preceding vehicles 200p).

In step S3, the lane determination unit 54 performs the primary determination process as to whether the travel lane L1 for the host vehicle 100 is an offset lane. Here, the term “offset lane” means a lane in which the lane over the intersection 108 is shifted with respect to the lane before the intersection 108 in a left-right direction. If the accuracy of recognizing the position of the host vehicle 100 by the satellite positioning device of the navigation device 16 is low, this primary determination process is performed with reference to the map information that expresses the periphery of the intersection 108.

Specifically, [1] if it is recognized that the first road 104 includes a plurality of lanes on one side (especially, three lanes or more) or [2] if the map information suggests that the travel lane L1 is the offset lane, the lane determination unit 54 determines that there is a possibility that the travel lane L1 is the offset lane.

In step S4, the lane determination unit 54 determines whether there is a possibility that the travel lane L1 is the offset lane. For example, if it is determined that there is no possibility for the intersection 108 in FIG. 3A (step S4: NO), the process advances to step S5.

In step S5, on the assumption that there is no offset of the travel lane L1, the lane determination unit 54 sets two border lines Br, Bl (including virtual section lines Er, El) to specify the shape of the travel lane L1.

As illustrated in FIG. 3B, the border line Br on the right side includes a near side section line Cr expressed by the lane mark 110 (FIG. 3A), a far side section line Dr expressed by the lane mark 112 (FIG. 3A), and the virtual section line Er that connects the near side section line Cr and the far side section line Dr. This virtual section line Er is a virtual line that is set in the intersection 108 and is a straight line.

The border line Bl on the left side includes a near side section line Cl specified by the road end 114 (FIG. 3A), a far side section line Dl specified by the road end 116 (FIG. 3A), and the virtual section line El that connects the near side section line Cl and the far side section line DI. This virtual section line El is a virtual line that is set in the intersection 108 and is a straight line.

In step S6, the travel control unit 44 (lane keep control unit 58) starts to perform the LKAS control for the travel lane L1 when the host vehicle 100 reaches an execution position P2 (FIG. 3B). Specifically, the lane keep control unit 58 decides the target trajectory (for example, center line) in the intersection 108 on the basis of the two virtual section lines Er, El set in step S5, and performs the control to cause the host vehicle 100 to travel along this target trajectory. Thus, the host vehicle 100 can enter the travel lane L1 on the far side while traveling smoothly in the intersection 108.

In step S7, the automated driving ECU 12 determines whether the host vehicle 100 has passed the intersection 108. If the host vehicle 100 has not passed the intersection 108 yet (step S7: NO), the process remains at step S7 until the host vehicle 100 passes the intersection 108. On the other hand, if the host vehicle 100 has passed the intersection 108 (step S7: YES), the process of the flowchart in FIG. 2 (processing control for the intersection 108) is terminated.

### <2. Vehicle Passes Intersection 126>

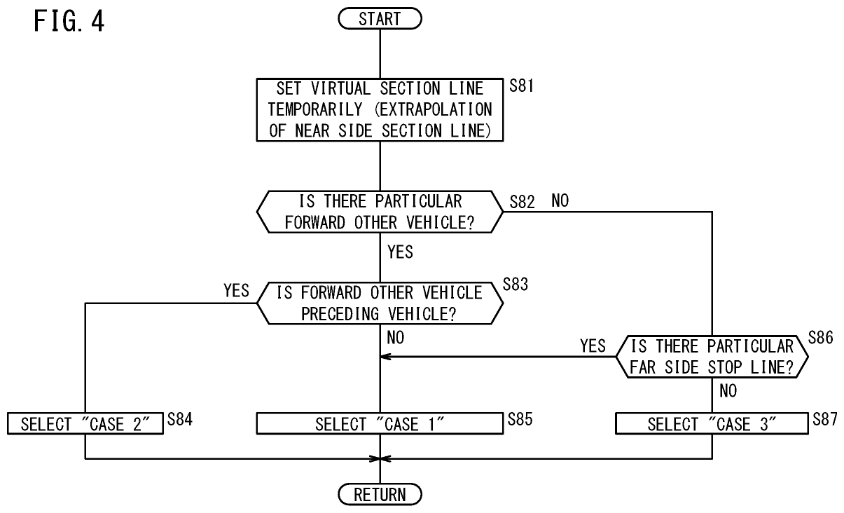

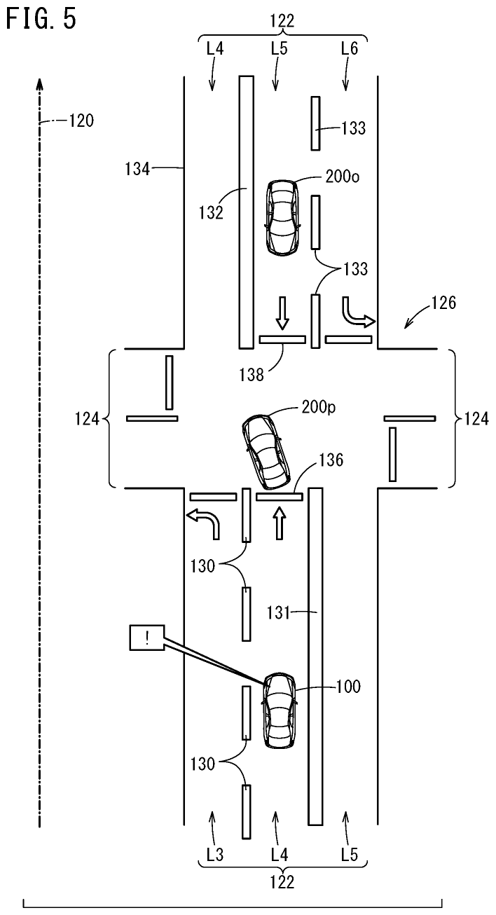

Next, the processing control for an intersection 126 (FIG. 5) different from that in FIG. 3A is described with reference to flowcharts in FIG. 2 and FIG. 4, and FIG. 5 to FIG. 10.

As illustrated in FIG. 5, the host vehicle 100 will pass a point where a first road 122 and a second road 124 intersect (that is, intersection 126) along a scheduled travel route 120 that is expressed by a dashed line arrow. Similarly to FIG. 3A, these drawings express the roads in a region where vehicles should travel on “left side” of the road.

The first road 122 is an irregular road including three lanes and the second road 124 includes two lanes (one lane on one side). The first road 122 before the intersection 126 includes, from a left side thereof, a left-turn only lane L3, a lane where the host vehicle 100 travels (hereinafter, travel lane L4), and a lane L5 that is opposite to the travel lane L4. The first road 122 over the intersection 126 includes, from a left side thereof, the travel lane L4 where the host vehicle 100 will travel, the lane L5 that is opposite to the travel lane L4, and a left-turn only lane L6.

A lane mark 130 with a broken line shape is a section line between the lane L3 and the travel lane L4 before the intersection 126. A lane mark 131 with a continuous linear shape is a section line between the travel lane L4 and the lane L5 before the intersection 126. A lane mark 132 with a continuous linear shape is a section line between the travel lane L4 and the lane L5 over the intersection 108. A lane mark 133 with a broken line shape is a section line between the lane L5 and the lane L6 over the intersection 126.

As this drawing shows, the intersection 126 is an offset intersection that includes the offset lanes (L4, L5). The travel lane L4 for the host vehicle 100 is sectioned by the lane marks 130, 131, 132 and a road end 134. That is to say, the travel lane L4 is the offset lane in which the lane over the intersection 126 is shifted to the left direction by just one lane with respect to the lane before the intersection 126. Note that the shape of the offset intersection is not limited to the example in FIG. 5, and that various shapes can be assumed. For example, the offset amount may be less than one lane.

As a result of the primary determination process shown in the flowchart in FIG. 2 (step S3), it is determined that there is a possibility that the travel lane L4 in FIG. 5 is the offset lane. In this case (step S4: YES), the process advances to step S8.

In step S8, the lane determination unit 54 performs the secondary determination process as to whether the travel lane L4 for the host vehicle 100 is the offset lane. A specific method for performing the secondary determination process is hereinafter described in detail with reference to the flowchart in FIG. 4.

In step S81 in FIG. 4, the lane determination unit 54 temporarily sets the two border lines Br, Bl (that is, two virtual section lines Er, El) by performing extrapolation processing to keep the near side section lines Cr, Cl at least continuous. For example, if the near side section lines Cr, Cl are straight lines (see FIG. 5), the lane determination unit 54 performs the extrapolation processing to extend the near side section lines Cr, Cl to the far side.

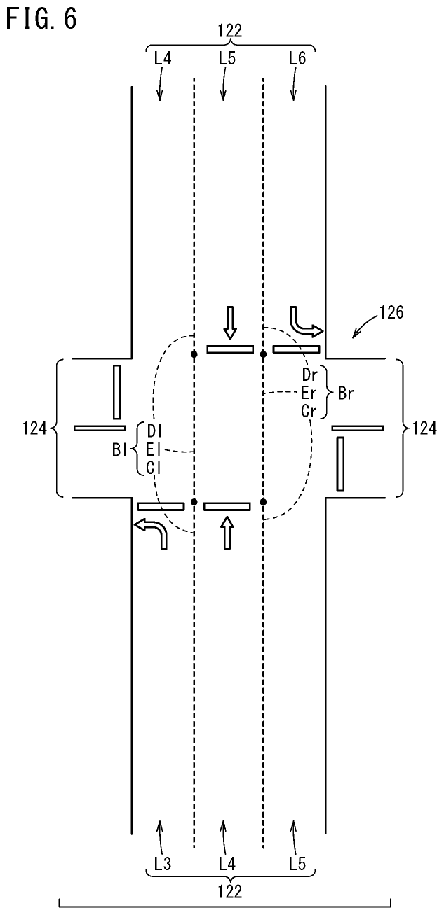

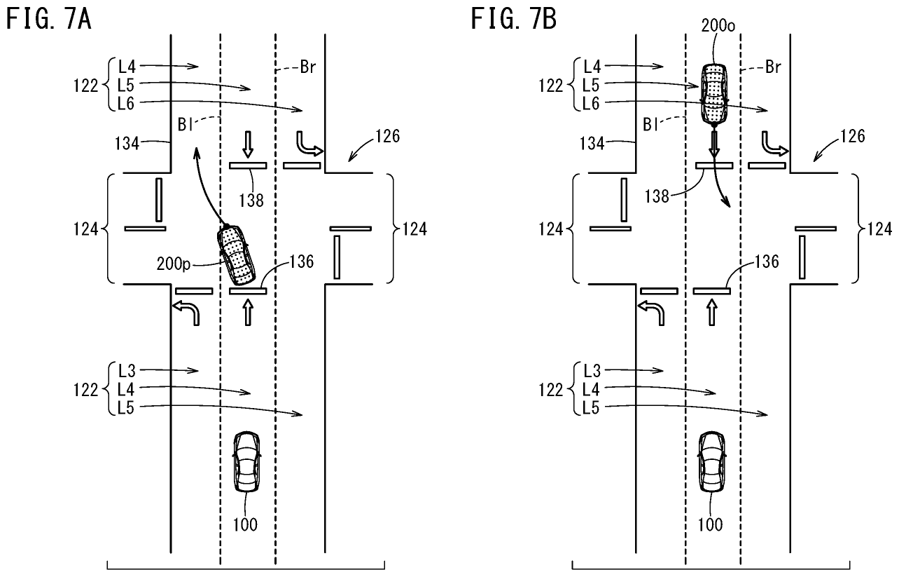

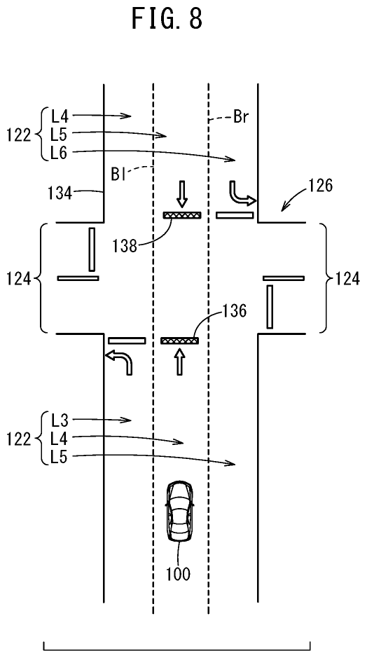

FIG. 6 illustrates a result of temporarily setting the virtual section lines Er, El in the intersection 126 in FIG. 5. Note that, for the convenience of the drawing, the lane marks 130 to 133 may be omitted. This similarly applies to FIG. 7A, FIG. 7B, and FIG. 8 to be described below.

As illustrated in FIG. 6, the border line Br on the right side includes the near side section line Cr corresponding to the lane mark 131 (FIG. 5), the far side section line Dr corresponding to the lane mark 133 (FIG. 5), and the virtual section line Er that connects the near side section line Cr and the far side section line Dr. The border line Bl on the left side includes the near side section line Cl corresponding to the lane mark 130 (FIG. 5), the far side section line Dl corresponding to the lane mark 132 (FIG. 5), and the virtual section line El that connects the near side section line Cl and the far side section line DI.

As described above, note that in the offset lane that is shifted to the left side by just one lane, as a result of the simple extrapolation of the near side section lines Cr, Cl, the border lines Br, Bl that connect the wrong section lines are obtained.

In step S82, the lane determination unit 54 determines whether there is a forward other vehicle that satisfies a particular positional relation. Specifically, the lane determination unit 54 determines whether at least a part of the forward other vehicle is on the same side as the host vehicle 100 with respect to the virtual section line Er (virtual section line El). If the forward other vehicle that satisfies the particular positional relation is present (step S82: YES), the process advances to step S83.

In step S83, the lane determination unit 54 determines whether the forward other vehicle is the preceding vehicle 200p by a known determination method using the absolute speed or the relative speed. If it is determined that the forward other vehicle is the preceding vehicle 200p (step S83: YES), “case 2” is selected (step S84) and the execution of the secondary determination process is terminated. On the other hand, if the forward other vehicle is not the preceding vehicle 200p (step S83: NO), “case 1” is selected (step S85) and the execution of the secondary determination process is terminated.

Back to step S82, if there is no forward other vehicle that satisfies the particular positional relation (step S82: NO), the process advances to step S86.

In step S86, the lane determination unit 54 determines whether there is a stop line 138 that satisfies a particular positional relation. Specifically, the lane determination unit 54 determines whether at least a part of the stop line 138 is [1] over the intersection 126 and [2] on the same side as the host vehicle 100 with respect to the virtual section line Er (virtual section line El).

If it is determined that the stop line 138 is present (step S86: YES), “case 1” is selected (step S85) and the execution of the secondary determination process is terminated. On the other hand, if it is determined that there is no stop line 138 (step S86: NO), “case 3” is selected (step S87) and the execution of the secondary determination process is terminated.

In a situation in FIG. 7A, a particular object (forward other vehicle) is approximately entirely on the same side as the host vehicle 100 with respect to the virtual section line El on the left side (border line Bl on left side). In addition, the movement direction of the forward other vehicle is approximately the same as the movement direction of the host vehicle 100. In this case, it is determined that the forward other vehicle is the preceding vehicle 200p, and “case 2” is selected.

In a situation in FIG. 7B, the particular object (forward other vehicle) is entirely on the same side as the host vehicle 100 with respect to the virtual section line Er on the right side (border line Br on right side). In addition, the movement direction of the forward other vehicle is approximately opposite to the movement direction of the host vehicle 100. In this case, it is determined that this particular object is an oncoming vehicle 2000, and “case 1” is selected.

In a situation in FIG. 8, two particular objects (two stop lines whose positions are different) are entirely on the same side as the host vehicle 100 with respect to the virtual section line Er on the right side (border line Br on right side). In this case, it is determined that one of the particular objects is the stop line 138 on the far side, and “case 1” is selected.

Back to the flowchart in FIG. 2, in step S9, the automated driving ECU 12 performs various operations in accordance with a determination result in step S8. If “case 1” where the host vehicle 100 is currently traveling on the offset lane is selected (step S9: case 1), the process advances to step S10.

In step S10, on the assumption that the travel lane L4 is the offset lane, the lane determination unit 54 sets the two border lines Br, Bl (including virtual section lines Er, El) to specify the shape of the travel lane L4. Here, the lane determination unit 54 sets the virtual section lines Er, El by reconnecting the near side section lines Cr, Cl to the far side section lines Dr, Dl that are closest to the near side section lines Cr, Cl in an offset direction. Note that the offset direction is “left direction” in the roads in a region where vehicles should travel in “left side” of the road.

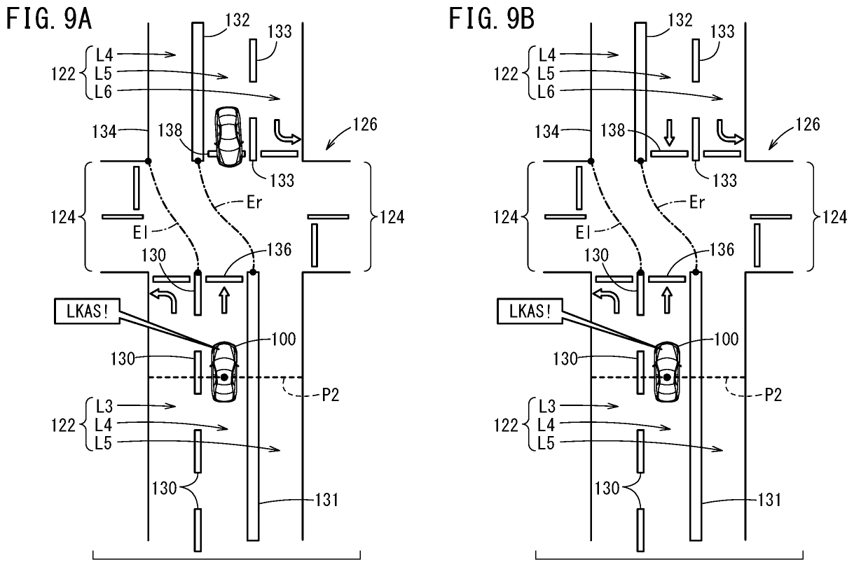

FIG. 9A illustrates the travel behavior of the host vehicle 100 in the situation in FIG. 7B. FIG. 9B illustrates the travel behavior of the host vehicle 100 in the situation in FIG. 8. In both FIG. 9A and FIG. 9B, the virtual section line Er that connects the lane mark 131 and the lane mark 132, and the virtual section line El that connects the lane mark 130 and the road end 134 are newly set. Here, each of the virtual section lines Er, El is a smoothly curved line. Alternatively, each of the virtual section lines Er, El may be a straight line or a combination of the straight line and the curved line.

After that, the process advances to step S6 and the travel control unit 44 (lane keep control unit 58) starts to perform the LKAS control for the travel lane L4 when the host vehicle 100 reaches the execution position P2 (FIG. 9A and FIG. 9B). Specifically, the lane keep control unit 58 decides the target trajectory (for example, center line) in the intersection 126 on the basis of the two virtual section lines Er, El set in step S10, and performs the control to cause the host vehicle 100 to travel along this target trajectory. Thus, the host vehicle 100 can enter the travel lane L4 on the far side while traveling smoothly in the intersection 126.

Back to step S9, if “case 2” where the preceding vehicle 200p is currently traveling on the travel lane L4 is selected (step S9: case 2), the process advances to step S11.

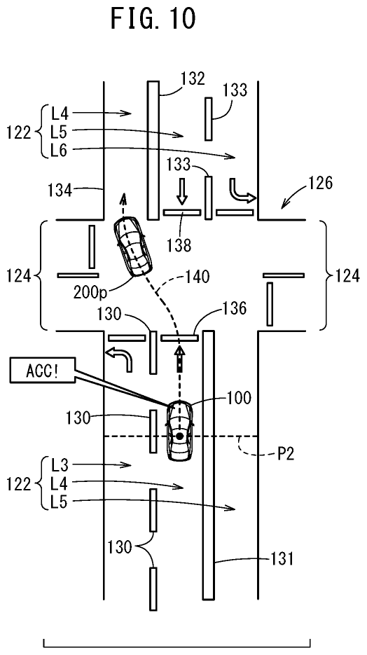

In step S11, the travel control unit 44 (following control unit 60) starts to perform the ACC control for the preceding vehicle 200p when the host vehicle 100 reaches the execution position P2 (FIG. 10). Specifically, the following control unit 60 performs the control to cause the host vehicle 100 to travel so as to follow a travel trajectory 140 of the preceding vehicle 200p that is expressed by a broken arrow.

FIG. 10 illustrates the travel behavior of the host vehicle 100 in the situation in FIG. 7A. As shown in this drawing, the host vehicle 100 can enter the travel lane L4 on the far side while following the preceding vehicle 200p.

Back to step S9, if “case 3” that is different from the cases 1, 2 is selected (step S9: case 3), the process advances to step S12.

In step S12, the intersection processing unit 42 (takeover request unit 56) works such that the automated driving is taken over to the manual driving. Specifically, the takeover request unit 56 requests the driver to perform the takeover (takeover operation) for the manual driving.

Then, the notification device 30 notifies the driver that the takeover should be performed in accordance with the notification instruction from the takeover request unit 56. A series of the operation from the request control to the notification operation is referred to as “TOR” (takeover request).

If the takeover operation by the driver is accepted, the vehicle control device 10 switches the driving mode from the automated driving mode to the manual driving mode. After that, the driver performs the manual driving to travel straight in the intersection 126 using the operation devices 20.

As described above, if the recognition processing unit 40 does not recognize the preceding vehicle 200p or the particular object (object on the opposite lane L5, for example, the oncoming vehicle 2000 or a stop line 136), the takeover request unit 56 may request the driver of the host vehicle 100 to perform the takeover for the manual driving. Thus, in a situation where it is difficult to determine the connectivity of the travel lane L4, the driver can smoothly take over the operation for driving.

In combination with or in addition to the request control, the vehicle control device 10 may perform notification control to alert the driver by the notification device 30, and the travel control to decelerate the host vehicle 100 to stop the host vehicle 100 at the stop line 136 by the travel control unit 44.

### [Effect of Vehicle Control Device 10]

As described above, the vehicle control device 10 is the device configured to perform the travel control of the host vehicle 100 at least partially automatically, the device including: [1] the recognition processing unit 40 configured to recognize the intersection 108, 126 that the host vehicle 100 will pass while traveling straight; [2] the lane determination unit 54 configured to determine whether the travel lane L1, L4 of the host vehicle 100 is the offset lane in which the travel lane L1, L4 over the intersection 108, 126 that is recognized is shifted with respect to the travel lane L1, L4 before the intersection 108, 126 in the left-right direction; and [3] the travel control unit 44 configured to perform various kinds of travel control in accordance with the determination result from the lane determination unit 54.

The vehicle control method using the vehicle control device 10 includes: [1] the recognition step (S1) of recognizing the intersection 108, 126 that the host vehicle 100 will pass while traveling straight; [2] the determination step (S3, S5) of determining whether the travel lane L1, L4 of the host vehicle 100 is the offset lane in which the travel lane L1, L4 over the recognized intersection 108, 126 is shifted with respect to the travel lane L1, L4 before the intersection 108, 126 in the left-right direction; and [3] the control step (S6, S11, S12) of performing various kinds of travel control in accordance with the determination result in the determination step.

As described above, by performing various kinds of travel control in accordance with the determination result regarding the offset lane, the host vehicle 100 can travel straight in the intersection 108, 126 as appropriate while the connectivity of the travel lane L1, L4 in the front-rear direction in the intersection 108, 126 is considered.

The recognition processing unit 40 may be configured to further recognize the lane marks 110, 112, 130 to 133 that express the section lines of the travel lane L1, L4, and the lane determination unit 54 may be configured to set virtual section lines Er, El in the intersection 108, 126 by performing extrapolation of near side section lines Cr, Cl of the intersection 108, 126 specified by the lane marks 110, 112, 130 to 133, and determine whether the travel lane L1, L4 is the offset lane on the basis of the virtual section lines Er, El.

If it is determined that the travel lane L1, L4 is the offset lane, the lane determination unit 54 may set the virtual section lines Er, El by reconnecting the near side section lines Cr, Cl to the far side section lines Dr, Dl that are closest to the near side section lines Cr, Cl in the offset direction.

The travel control unit 44 may be configured to perform the LKAS control (lane keep control) for the virtual section lines Er, El set by the lane determination unit 54 in the intersection 108, 126.

The recognition processing unit 40 may be configured to further recognize one or the plurality of particular objects ahead of the host vehicle 100, and if at least a part of the particular object is on the same side as the host vehicle 100 with respect to the virtual section line Er, El, the lane determination unit 54 may determine that the travel lane L4 is the offset lane. Thus, the determination can be performed with high accuracy by using the positional relation with the particular object that may exist in the next lane (that is, opposite lane L5).

The recognition processing unit 40 may be configured to recognize, as the particular object, the oncoming vehicle 2000 ahead of the host vehicle 100 and/or the stop line 138 over the intersection 126.

The recognition processing unit 40 may be configured to further recognize the preceding vehicle 200p ahead of the host vehicle 100, and if the recognition processing unit 40 recognizes the preceding vehicle 200p, the travel control unit 44 may perform the ACC control (following control) for the preceding vehicle 200p in the intersection 126. Thus, the host vehicle 100 can pass the intersection 126 in accordance with the behavior of the preceding vehicle 200p without considering the connectivity of the travel lane L4.

The vehicle control device 10 may further include the takeover request unit 56 to request the driver of the host vehicle 100 to perform the takeover for the manual driving if the recognition processing unit 40 does not recognize the particular object or the preceding vehicle 200p. Thus, in the situation where it is difficult to determine the connectivity of the travel lane L4, the driver can smoothly start to drive.

If it is determined that the travel lane L4 is the offset lane, the lane determination unit 54 may set the virtual section lines Er, El in the intersection 126 by connecting the near side section lines Cr, Cl with respect to the intersection 126 to the far side section lines Dr, Dl that are closest to the near side section lines Cr, Cl in the offset direction.

### [Remarks]

The present invention is not limited to the embodiment described above, and can be changed freely within the range not departing from the gist of the present invention. Alternatively, the configurations can be combined arbitrarily within the range not contradicting each other technically.

1. A vehicle control device configured to perform travel control of a host vehicle at least partially automatically, the vehicle control device comprising:
a recognition processing unit configured to recognize an intersection that the host vehicle will pass while traveling straight;
a lane determination unit configured to determine whether a travel lane of the host vehicle is an offset lane in which the travel lane over the intersection that is recognized by the recognition processing unit is shifted with respect to the travel lane before the intersection in a left-right direction; and
a travel control unit configured to perform various kinds of travel control in accordance with a determination result from the lane determination unit.

2. The vehicle control device according to claim 1, wherein:
the recognition processing unit is configured to further recognize lane marks that express section lines of the travel lane; and
the lane determination unit is configured to set virtual section lines in the intersection by performing extrapolation of near side section lines of the intersection specified by the lane marks, and determine whether the travel lane is the offset lane on a basis of the virtual section lines.

3. The vehicle control device according to claim 2, wherein if it is determined that the travel lane is the offset lane, the lane determination unit sets the virtual section lines by reconnecting the near side section lines to far side section lines that are closest to the near side section lines in an offset direction.

4. The vehicle control device according to claim 2, wherein the travel control unit is configured to perform lane keep control for the virtual section lines set by the lane determination unit in the intersection.

5. The vehicle control device according to claim 2, wherein:
the recognition processing unit is configured to further recognize one or a plurality of particular objects ahead of the host vehicle; and
if at least a part of the particular object is on the same side as the host vehicle with respect to the virtual section line, the lane determination unit determines that the travel lane is the offset lane.

6. The vehicle control device according to claim 5, wherein the recognition processing unit is configured to recognize, as the particular object, an oncoming vehicle ahead of the host vehicle; and/or a stop line over the intersection.

7. The vehicle control device according to claim 5, wherein:
the recognition processing unit is configured to further recognize a preceding vehicle ahead of the host vehicle; and
if the recognition processing unit recognizes the preceding vehicle, the travel control unit performs following control for the preceding vehicle in the intersection.

8. The vehicle control device according to claim 7, further comprising a takeover request unit to request a driver of the host vehicle to perform a takeover for manual driving if the recognition processing unit does not recognize the particular object or the preceding vehicle.

9. The vehicle control device according to claim 1, wherein if it is determined that the travel lane is the offset lane, the lane determination unit sets the virtual section lines in the intersection by connecting near side section lines with respect to the intersection to far side section lines that are closest to the near side section lines in an offset direction.

10. A vehicle control method using a vehicle control device configured to perform travel control of a host vehicle at least partially automatically, comprising:
a recognition step of recognizing an intersection that the host vehicle will pass while traveling straight;
a determination step of determining whether a travel lane of the host vehicle is an offset lane in which the travel lane over the recognized intersection is shifted with respect to the travel lane before the intersection in a left-right direction; and
a control step of performing various kinds of travel control in accordance with a determination result in the determination step.
